(19) United States
(12) Patent Application Publication
(10) Pub. No.: US 2010/0181809 A1
(43) Pub. Date: Jul. 22, 2010

(54) Doggie Seat

(76) Inventor: Trina Jones, Arlington, TX (US)

Correspondence Address: Trina Jones, 5826 Tinsley Dr, Arlington, TX, 76017, US

(21) Appl. No.: 12/403,071

(22) Filed: Mar. 12, 2009

Related U.S. Application Data
(60) Provisional application No. 61/069,093, filed on Mar. 12, 2008.

(51) Int. Cl. B60N 2/24; B60N 2/44; B60N 2/58

(52) U.S. Cl. 297/174 R; 297/256.15; 297/254

(57) ABSTRACT

A portable seat for a pet for cooperating with the vehicle seat may include a seatback to cooperate with the back of the vehicle seat. a seat bottom to cooperate with the bottom of the vehicle seat, a pair of opposing seat sides to extend from the seat bottom and the seatback, and a pivotable animal retention tray which may pivot with respect to the opposing seat sides. The portable animal seat may include a top cover section to cover a top surface of the seatback, and the portable animal seat may include a back cover section to cover a front surface of the seatback. The portable animal seat may include a seat cover section in order to cover a top surface of the seat bottom, and the seatback may include a mechanical release. The seatback may include a detachable strap assembly to cooperate with the mechanical release, and the detachable strap assembly may include a expandable and retractable strap which operates in response to the mechanical release.

### PRIORITY

The present invention claims party under 35 USC section 119 and based on provisional application 61/069,093 which was filed on Mar. 12, 2008.

### FIELD OF THE INVENTION

The present invention is related to a pet seat for use in a vehicle more particularly to a pet seat with an animal retention tray.

### BACKGROUND

It has long been a desire to allow pets to travel in vehicles. It is known that pets traveling in a vehicle can create particular safety problems for the driver including interfering with the steering mechanism or pedals and obstructing the view of the driver. These safety problems are to be avoided.

In addition to the safety problems associated with interference, there are safety risk to the pet if an accident occurs. In most jurisdictions, passengers are required to be secured by safety belts to limit injury if a collision occurs. Pets are not required to be secured and, in the event of a collision, can be catapulted within the vehicle causing harm to the pet or passengers.

Many devices have been developed for transporting a pet in a vehicle. Many of these involve a strap, of some type, for securing the pet seat to the vehicle. Examples include the Portable Pet Booster Seat Apparatus of O'Donnell described in U.S. Pat. No. 5,551,373 wherein the car seat belt secures the pet seat. The pet is unrestrained. A similar apparatus is described as a Pet Carrier Apparatus, also by O'Donnell, in U.S. Pat. No. 5,718,191 wherein the pet is ultimately secured to the seat post of a bicycle.

U.S. Pat. No. 7,448,345 discloses a console pet seat. The console pet seat comprises a central frame comprising sides and a bottom forming a bed section. A front strap forms a loop for securing to a vehicle console. A rear strap assembly comprises a primary strap with a first end and a second end. A first secondary strap is attached to the first end of the rear strap and a second secondary strap attached to the second end of the rear strap. A tether is attached to the primary strap between the first end and the second end and located in the bed section.

### SUMMARY

A portable seat for a pet for cooperating with the vehicle seat may include a seatback to cooperate with the back of the vehicle seat. a seat bottom to cooperate with the bottom of the vehicle seat, a pair of opposing seat sides to extend from the seat bottom and the seatback, and a pivotable animal retention tray which may pivot with respect to the opposing seat sides.

The portable animal seat may include a top cover section to cover a top surface of the seatback, and the portable animal seat may include a back cover section to cover a front surface of the seatback.

The portable animal seat may include a seat cover section in order to cover a top surface of the seat bottom, and the seatback may include a mechanical release.

The seatback may include a detachable strap assembly to cooperate with the mechanical release, and the detachable strap assembly may include a expandable and retractable strap which operates in response to the mechanical release.

The animal retention tray may include an aperture adapted for a bowl or dish, and the seatback may include a bracket assembly to attach to the seat of the vehicle.

### BRIEF DESCRIPTION OF THE DRAWINGS

The invention may be understood by reference to the following description taken in conjunction with the accompanying drawings, in which, like reference numerals identify like elements, and in which:

FIG. 1 is a exploded perspective view of the doggie seat of the present invention;

FIG. 2 is a back view of the doggie seat of the present invention;

FIG. 3 is a exploded front view of the doggie seat of the present invention;

FIG. 4 is an exploded side view of the doggie seat of the present invention;

FIG. 5 is a perspective view of the doggie seat with the animal retaining tray in a closed position.

FIG. 6 is a perspective view of the doggie seat with the animal retaining tray in the open position.

### DETAILED DESCRIPTION

The doggie seat may be a car seat to be used in a car, truck or other such vehicle that safely secures a dog or other type of animal in a comfortable cushion seat. The seat may restrict the animal (pet) from roaming freely in the vehicle while the vehicle is in motion. The pet should stay restrained within the seat by a harness which may be detached (unhooked) from the car seat and used as a leash. The seat and a harness may be connected to an internal strap that may be adjusted by using a mechanical release device such as the release lever. Using the release lever the strap length may be adjusted in order to provide for more or less movement while the pet is in the doggie seat. The doggie seat adds to the safety more particularly the driving safety for the owner and the pet by avoiding a pet related accident.

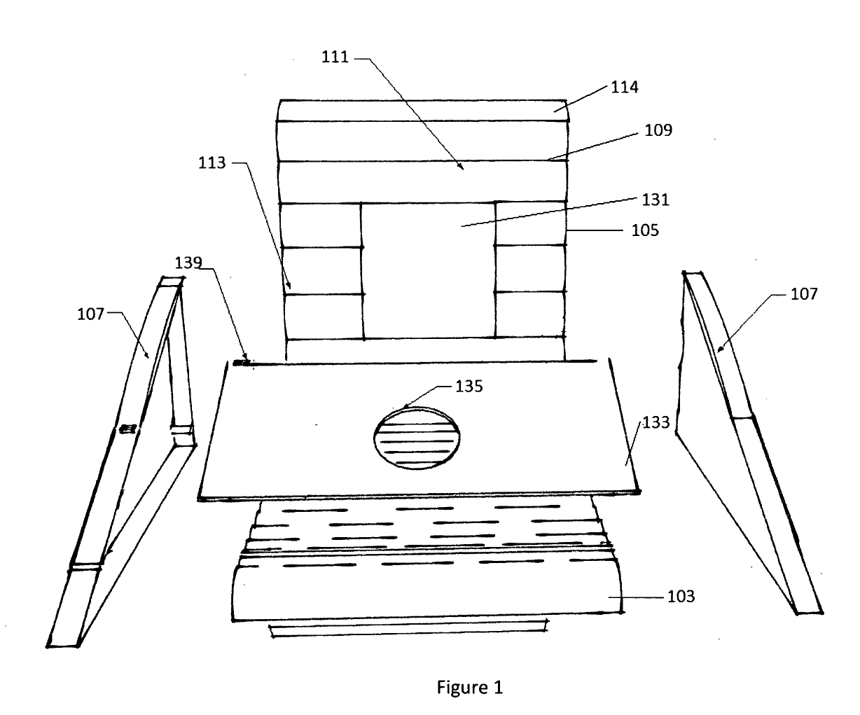

FIG. 1 illustrates the doggie seat or the pet seat 100 of the present invention and illustrates a vehicle seat 101 which may cooperate with the pet seat 100. The pet seat 100 may include a seat bottom 103 and seat back 105 which may be detachably or integrally connected to form a substantial L-shaped pet seat 100. The seat bottom 103 may be placed on the bottom surface of the vehicle seat 101 while the seatback 105 may be placed against the back surface of the vehicle seat 101.

The front surface of the seatback 105 may include a detachable connection section 131 to cooperate with a mechanical release 119 and to cooperate with the detachable strap assembly 115. The front surface of the seatback 105, the top surface of the seatback 105 and the top surface of the seat bottom 103 may cooperate with a seat cover 109 which may include seatback cover section 113, a top cover section 114 and a seat bottom cover section 111 to cover the front surface of the seatback 105, the top surface of the seatback 105 and the top surface of the seat bottom 103 respectively. The seat bottom section 111, the top cover section 114 and the seat cover section 113 may be formed from a foam flexible material, such as sponge, foam or other appropriate material in order to provide a flexible and comfortable covering for the pet. The portable animal seat 100 may include a seat sidewall 107 which may extend from the seatback 105 to the seat bottom 103 in order to additionally restrain the pet within the portable animal seat 100. The top surface of the seat side wall 107 may be inclined in order to provide a view for the pet within the portable animal seat 100. Each side of the portable animal seat 100 may include an opposing seat sidewall 107 and the portable animal seat 100 may include a animal retention tray 133 or top cover section or wall which may extend between the seat sidewalls 107 and may extend to the top surface of the seat bottom 103 or may discontinuously extend along the top surface of the seat sidewalls 107. The animal retention tray 133 may pivot for example on hinges to extend forward of the portable animal seat 100 in order to provide a tray for the animal to eat and drink. The animal retention tray 133 may include an aperture 135 to cooperate with a bowl for food or drink. The back surface of the seatback 105 may include a bracket assembly 137 and may include a bracket to cooperate with the seat belt of the vehicle in order to hold the portable animal seat 100 in position.

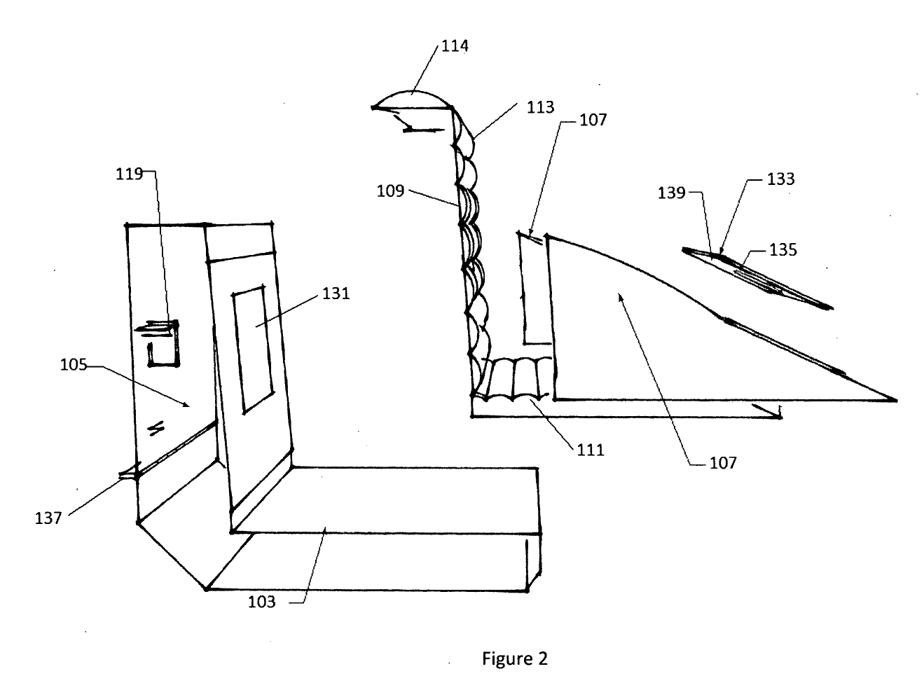

FIG. 2 illustrates the doggie seat or the pet seat 100 of the present invention. The pet seat 100 may include a seat bottom 103 and seat back 105 which may be detachably or integrally connected to form a substantial L-shaped pet seat 100. The seat bottom 103 may be placed on the bottom surface of the vehicle seat 101 (as shown in FIG. 1) while the seatback 105 may be placed against the back surface of the vehicle seat 101.

The front surface of the seatback 105 may include a detachable connection section 131 to cooperate with a mechanical release 119 and to cooperate with the detachable strap assembly 115. The front surface of the seatback 105, the top surface of the seatback 105 and the top surface of the seat bottom 103 may cooperate with a seat cover 109 which may include seatback cover section 113, a top cover section 114 and a seat bottom cover section 111 to cover the front surface of the seatback 105, the top surface of the seatback 105 and the top surface of the seat bottom 103 respectively. The seat bottom section 111, the top cover section 114 and the seat cover section 113 may be formed from a foam flexible material, such as sponge, foam or other appropriate material in order to provide a flexible and comfortable covering for the pet. The portable animal seat 100 may include a seat sidewall 107 which may extend from the seatback 105 to the seat bottom 103 in order to additionally restrain the pet within the portable animal seat 100. The top surface of the seat side wall 107 may be inclined in order to provide a view for the pet within the portable animal seat 100. Each side of the portable animal seat 100 may include an opposing seat sidewall 107 and the portable animal seat 100 may include a animal retention tray 133 (shown in FIG. 1) or top cover section or wall which may extend between the seat sidewalls 107 and may extend to the top surface of the seat bottom 103 or may discontinuously extend along the top surface of the seat sidewalls 107. The animal retention tray 133 may pivot for example on hinges 139 to extend forward of the portable animal seat 100 in order to provide a tray for the animal to eat and drink. The animal retention tray 133 may include an aperture 135 to cooperate with a bowl for food or drink. The back surface of the seatback 105 may include a bracket assembly 137 and may include a bracket to cooperate with the seat belt of the vehicle in order to hold the portable animal seat 100 in position.

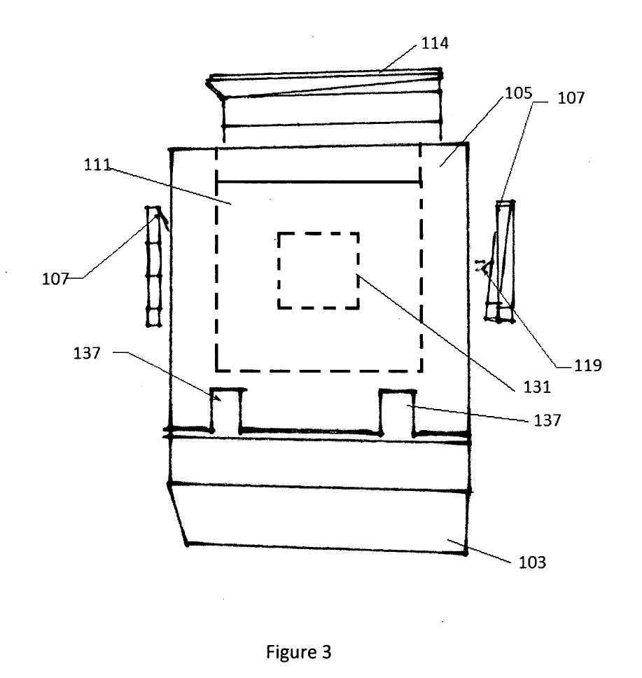

FIG. 3 illustrates the doggie seat or the pet seat 100 of the present invention. The pet seat 100 may include a seat bottom 103 and seat back 105 which may be detachably or integrally connected to form a substantial L-shaped pet seat 100. The seat bottom 103 may be placed on the bottom surface of the vehicle seat 101 (as shown in FIG. 1) while the seatback 105 may be placed against the back surface of the vehicle seat 101.

The front surface of the seatback 105 may include a detachable connection section 131 to cooperate with a mechanical release 119 and to cooperate with the detachable strap assembly 115. The front surface of the seatback 105, the top surface of the seatback 105 and the top surface of the seat bottom 103 may cooperate with a seat cover 109 which may include seatback cover section 113, a top cover section 114 and a seat bottom cover section 111 to cover the front surface of the seatback 105, the top surface of the seatback 105 and the top surface of the seat bottom 103 respectively. The seat bottom section 111, the top cover section 114 and the seat cover section 113 may be formed from a foam flexible material, such as sponge, foam or other appropriate material in order to provide a flexible and comfortable covering for the pet. The portable animal seat 100 may include a seat sidewall 107 which may extend from the seatback 105 to the seat bottom 103 in order to additionally restrain the pet within the portable animal seat 100. The top surface of the seat side wall 107 may be inclined in order to provide a view for the pet within the portable animal seat 100. Each side of the portable animal seat 100 may include an opposing seat sidewall 107 and the portable animal seat 100 may include a animal retention tray 133 (shown in FIG. 1) or top cover section or wall which may extend between the seat sidewalls 107 and may extend to the top surface of the seat bottom 103 or may discontinuously extend along the top surface of the seat sidewalls 107. The animal retention tray 133 may pivot for example on hinges 139 to extend forward of the portable animal seat 100 in order to provide a tray for the animal to eat and drink. The animal retention tray 133 may include an aperture 135 to cooperate with a bowl for food or drink. The back surface of the seatback 105 may include a bracket assembly 137 and may include a bracket to cooperate with the seat belt of the vehicle in order to hold the portable animal seat 100 in position.

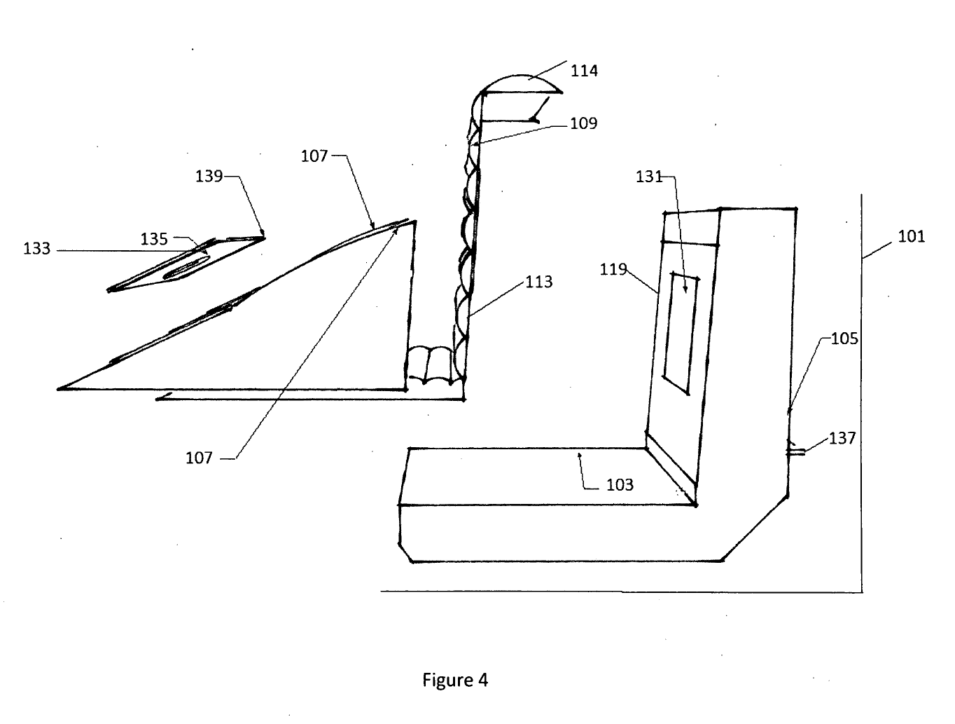

FIG. 4 illustrates the doggie seat or the pet seat 100 of the present invention. The pet seat 100 may include a seat bottom 103 and seat back 105 which may be detachably or integrally connected to form a substantial L-shaped pet seat 100. The seat bottom 103 may be placed on the bottom surface of the vehicle seat 101 (as shown in FIG. 1) while the seatback 105 may be placed against the back surface of the vehicle seat 101.

The front surface of the seatback 105 may include a detachable connection section 131 to cooperate with a mechanical release 119 and to cooperate with the detachable strap assembly 115. The front surface of the seatback 105, the top surface of the seatback 105 and the top surface of the seat bottom 103 may cooperate with a seat cover 109 which may include seatback cover section 113, a top cover section 114 and a seat bottom cover section 111 to cover the front surface of the seatback 105, the top surface of the seatback 105 and the top surface of the seat bottom 103 respectively. The seat bottom section 111, the top cover section 114 and the seat cover section 113 may be formed from a foam flexible material, such as sponge, foam or other appropriate material in order to provide a flexible and comfortable covering for the pet. The portable animal seat 100 may include a seat sidewall 107 which may extend from the seatback 105 to the seat bottom 103 in order to additionally restrain the pet within the portable animal seat 100. The top surface of the seat side wall 107 may be inclined in order to provide a view for the pet within the portable animal seat 100. Each side of the portable animal seat 100 may include an opposing seat sidewall 107 and the portable animal seat 100 may include a animal retention tray 133 (shown in FIG. 1) or top cover section or wall which may extend between the seat sidewalls 107 and may extend to the top surface of the seat bottom 103 or may discontinuously extend along the top surface of the seat sidewalls 107. The animal retention tray 133 may pivot for example on hinges 139 to extend forward of the portable animal seat 100 in order to provide a tray for the animal to eat and drink. The animal retention tray 133 may include an aperture 135 to cooperate with a bowl for food or drink. The back surface of the seatback 105 may include a bracket assembly 137 and may include a bracket to cooperate with the seat belt of the vehicle in order to hold the portable animal seat 100 in position.

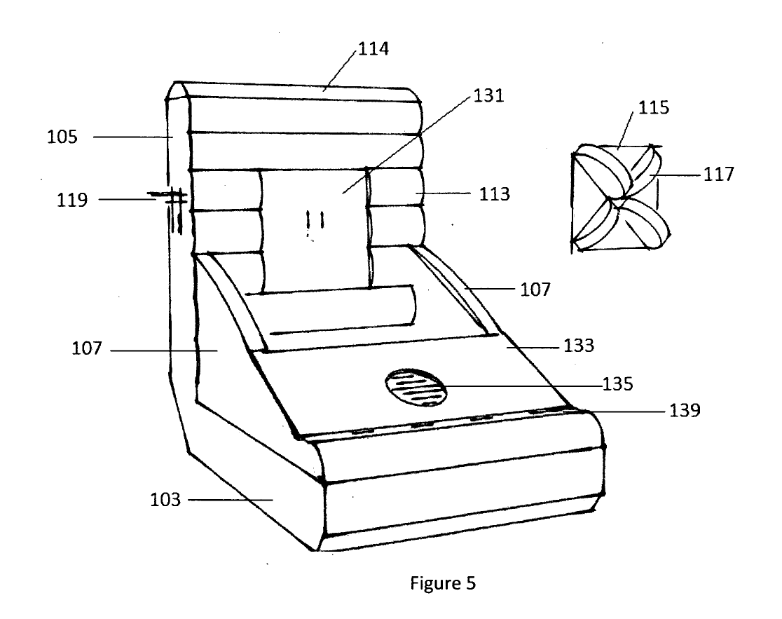

FIG. 5 illustrates the doggie seat or the pet seat 100 of the present invention. The pet seat 100 may include a seat bottom 103 and seat back 105 which may be detachably or integrally connected to form a substantial L-shaped pet seat 100. The seat bottom 103 may be placed on the bottom surface of the vehicle seat 101 (as shown in FIG. 1) while the seatback 105 may be placed against the back surface of the vehicle seat 101.

The front surface of the seatback 105 may include a detachable connection section 131 to cooperate with a mechanical release 119 and to cooperate with the detachable strap assembly 115. The front surface of the seatback 105, the top surface of the seatback 105 and the top surface of the seat bottom 103 may cooperate with a seat cover 109 which may include seatback cover section 113, a top cover section 114 and a seat bottom cover section 111 to cover the front surface of the seatback 105, the top surface of the seatback 105 and the top surface of the seat bottom 103 respectively. The seat bottom section 111, the top cover section 114 and the seat cover section 113 may be formed from a foam flexible material, such as sponge, foam or other appropriate material in order to provide a flexible and comfortable covering for the pet. The portable animal seat 100 may include a seat sidewall 107 which may extend from the seatback 105 to the seat bottom 103 in order to additionally restrain the pet within the portable animal seat 100. The top surface of the seat side wall 107 may be inclined in order to provide a view for the pet within the portable animal seat 100. Each side of the portable animal seat 100 may include an opposing seat sidewall 107 and the portable animal seat 100 may include a animal retention tray 133 (shown in FIG. 1) or top cover section or wall which may extend between the seat sidewalls 107 and may extend to the top surface of the seat bottom 103 or may discontinuously extend along the top surface of the seat sidewalls 107. The animal retention tray 133 may pivot for example on hinges 139 to extend forward of the portable animal seat 100 in order to provide a tray for the animal to eat and drink. The animal retention tray 133 may include an aperture 135 to cooperate with a bowl for food or drink. The back surface of the seatback 105 may include a bracket assembly 137 and may include a bracket to cooperate with the seat belt of the vehicle in order to hold the portable animal seat 100 in position.

FIG. 5 illustrates the detachable strap assembly 115 has been disconnected from the detachable connection section 131 and that the animal retention tray 133 is in a stowed position.

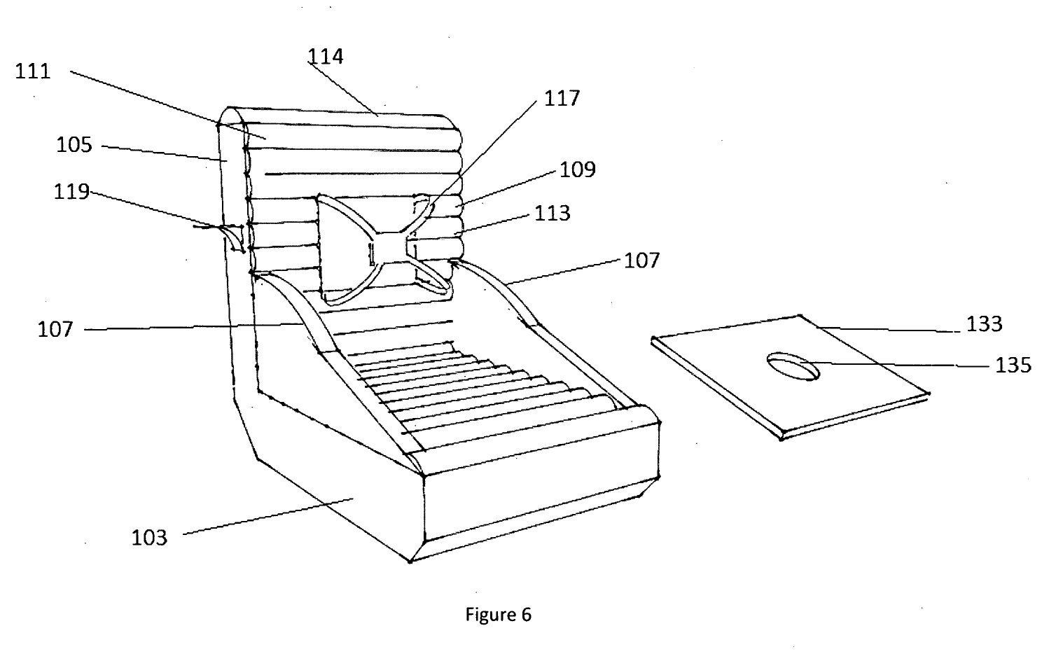

FIG. 6 illustrates the doggie seat or the pet seat 100 of the present invention. The pet seat 100 may include a seat bottom 103 and seat back 105 which may be detachably or integrally connected to form a substantial L-shaped pet seat 100. The seat bottom 103 may be placed on the bottom surface of the vehicle seat 101 (as shown in FIG. 1) while the seatback 105 may be placed against the back surface of the vehicle seat 101.

The front surface of the seatback 105 may include a detachable connection section 131 to cooperate with a mechanical release 119 and to cooperate with the detachable strap assembly 115. The front surface of the seatback 105, the top surface of the seatback 105 and the top surface of the seat bottom 103 may cooperate with a seat cover 109 which may include seatback cover section 113, a top cover section 114 and a seat bottom cover section 111 to cover the front surface of the seatback 105, the top surface of the seatback 105 and the top surface of the seat bottom 103 respectively. The seat bottom section 111, the top cover section 114 and the seat cover section 113 may be formed from a foam flexible material, such as sponge, foam or other appropriate material in order to provide a flexible and comfortable covering for the pet. The portable animal seat 100 may include a seat sidewall 107 which may extend from the seatback 105 to the seat bottom 103 in order to additionally restrain the pet within the portable animal seat 100. The top surface of the seat side wall 107 may be inclined in order to provide a view for the pet within the portable animal seat 100. Each side of the portable animal seat 100 may include an opposing seat sidewall 107 and the portable animal seat 100 may include a animal retention tray 133 (shown in FIG. 1) or top cover section or wall which may extend between the seat sidewalls 107 and may extend to the top surface of the seat bottom 103 or may discontinuously extend along the top surface of the seat sidewalls 107. The animal retention tray 133 may pivot for example on hinges 139 to extend forward of the portable animal seat 100 in order to provide a tray for the animal to eat and drink. The animal retention tray 133 may include an aperture 135 to cooperate with a bowl for food or drink. The back surface of the seatback 105 may include a bracket assembly 137 and may include a bracket to cooperate with the seat belt of the vehicle in order to hold the portable animal seat 100 in position.

FIG. 6 illustrates that the detachable strap assembly 115 is connected to the detachable connection section 131 and that the mechanical release 119 is connected to the restraining straps 117 and may release the restraining straps 117 to increase the length of the restraining straps 117 in order that the restraining straps 117 could be placed over a dog or other type of pet. Additionally the mechanical release 119 may withdraw the restraining straps 117 to decrease the length of the restraining straps 117 in order that the restraining straps 117 achieve a proper fit with the pet such as a dog.

FIG. 6 additionally illustrates that the animal retention tray 113 has been pivoted in order to be placed in an open position.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A portable seat for a pet for cooperating with the vehicle seat, comprising:
a seatback to cooperate with the back of the vehicle seat;
a seat bottom to cooperate with the bottom of the vehicle seat;
a pair of opposing seat sides to extend from the seat bottom and the seatback;
a pivotable animal retention tray which may pivot with respect to the opposing seat sides.

2) A portable seat for a pet for cooperating with the vehicle seat as in claim 1, wherein the portable animal seat includes a top cover section to cover a top surface of the seatback.

3) A portable seat for a pet for cooperating with the vehicle seat as in claim 1, wherein the portable animal seat includes a back cover section to cover a front surface of the seatback.

4) A portable seat for a pet for cooperating with the vehicle seat as in claim 1, wherein the portable animal seat includes a seat cover section in order to cover a top surface of the seat bottom.

5) A portable seat for a pet for cooperating with the vehicle seat as in claim 1, wherein the seatback includes a mechanical release.

6) A portable seat for a pet for cooperating with the vehicle seat as in claim 5, wherein the seatback includes a detachable strap assembly to cooperate with the mechanical release.

7) A portable seat for a pet for cooperating with the vehicle seat as in claim 6, wherein the detachable strap assembly includes a expandable and retractable strap which operates in response to the mechanical release.

8) A portable seat for a pet for cooperating with the vehicle seat as in claim 1, wherein the animal retention tray includes an aperture adapted for a bowl or dish.

9) A portable seat for a pet for cooperating with the vehicle seat as in claim 1, wherein the seatback includes a bracket assembly to attach to the seat of the vehicle.
